(19) United States
(12) Patent Application Publication
(10) Pub. No.: US 2005/0217804 A1
(43) Pub. Date: Oct. 6, 2005

(54) Efficient shutter assembly

(76) Inventor: Benjamin Wilkins, (US)

Correspondence Address: Ira J. Nasserian;Law Offices of Ira J. Nasserian & Associates, Suite 200, 2250 E. Imperial HWY., El Segundo, CA, 90245, US

(21) Appl. No.: 10/816,981

(22) Filed: Apr. 2, 2004

(51) Int. Cl. E06B 3/48

(52) U.S. Cl. 160/113

(57) ABSTRACT

A shutter assembly to shield an enclosure from environmental elements. The shutter assembly efficiently excludes unwanted light and dust from entering the enclosure while helping control of temperature within the enclosure. In one embodiment, the moveable flat plats slides behind the stationary flat plats. In furtherance of the present embodiment, the opening and closing of the shutter assembly takes place in a single plane. In another embodiment, the moveable flat plats wraps around the stationary flat plats when the shutter assembly is in its open position. In either of the embodiments neither moveable flat plats nor stationary flat plats extend inside the enclosure.

### FIELD OF THE INVENTION

The present invention relates to a shutter assembly with actuation system that enables a more complete manipulation and closure of a window resulting in a more precise operation and a more complete light or air blockage into a closed structure.

### BACKGROUND OF THE INVENTION

Window shutters have been in use for a long time and are well known in the construction industry. The use of shutters is many folds among which are to shield the interior of a structure from light, dust, hot or cold air and also in many occasions such protective means are used for decorative purposes and ensuring privacy of inhabitants of the enclosure.

Early shutters were typically made out of wood and were subject to assortment of problems such as rotting, warpage and dimensional changes due to moisture absorption. The introduction of polyvinyl chloride (PVC) to replace wood in manufacturing shutter was a partial response to rotting of wooden material. The use of PVC in manufacture of shutter added a new wrinkle resulting from lack of strength and structural stability. Such problems have been addressed in U.S. Pat. No. 5,941,021, in which the invention provided a means to reinforce the louvered slats with a metal bar. However, the type of reinforcement suggested in this design is costly, difficult to manufacture, and introduces added weight to the system.

Another window covering shutter is the type which folds over window and door and have been in use for a long time. The louvers of the shutter are either fixed or pivoting. Pivoting louvers are typically hinged at their end points by a pair of projections which mate with a pair of bearing bores. The louvers are installed vertically or horizontally which in and of itself introduces another problem of light or dust passing between the adjacent pairs of louvers.

The problems enumerated above requires a high degree of precise manufacturing, inspection and tollerancing in order to yield shutters which can block out the least amount of dust, light and provide a high degree of privacy to habitants of a structure.

Therefore, a need exist for an improved shutter system that provides a user with high degree of privacy, and exposes the habitants of an enclosed structure with minimum amount of dust, light and a high degree of control over the amount of air passing through the window. Still another need exist for a shutter that can provide protective advantages enumerated above as well as being aesthetically pleasant and in conformity with the enclosure's decoration.

### SUMMARY OF THE INVENTION

Accordingly, embodiments of the present invention provide a user with various shutters assembly that are convenient to operate, aesthetically attractive, while efficiently controlling passage of air, dust, noise and light into or out of an enclosure.

One embodiment of the present invention provides a user with a shutter assembly that is comprised of a number of flat plats made of hard material (e.g., wood, plastic, etc . . . ). According to this embodiment of the present invention, the shutter assembly comprises of a number of flat plats where every other flat plats is a stationary flat plats or a moveable flat plats. The user can move the moveable flat plats upwardly or downwardly. The shutter assembly is in its open position when the moveable flat plats are moved either upwardly or downwardly and are positioned behind the stationary flat plats of the shutter assembly. Positioning the moveable flat plats behind the stationary flat plats provides a number of apertures between two adjacent stationary flat plats through these apertures air, and light can flow in and out of an enclosure protected by the shutter assembly.

It is appreciated that stationary flat plats and moveable flat plat can be installed either substantially horizontal or substantially vertical. In case where moveable flats plats and stationary flat plats are installed substantially vertical, the user can move the moveable flat plats relative to stationary flat plats eastwardly or westwardly. Such movement of moveable flat plats results in a number of apertures through these aperture air, and light can flow freely.

In another embodiment of the present invention the shutter assembly comprises of a number of moveable flat plats and stationary flat plats where every other flat plats is a stationary flat plats or a moveable flat plats. According to this embodiment of the present invention, the moveable flat plats are made out of soft material (e.g., cloth, soft plastic material, . . . ). The moveable flat plats are mechanically coupled to a substantially vertical cylindrical axis or to a substantially horizontal cylindrical axis. The moveable flat plats, made out of soft material, are capable of being wrapped around the substantially vertical cylindrical axis or the substantially horizontal cylindrical axis.

According to this embodiment of the present invention, the soft material moveable flat plats are wrapped around the substantially vertical cylindrical axis or substantially horizontal cylindrical axis, when the shutter assembly in its fully open position, thus providing a number of rectangular apertures between two adjacent stationary flat plats. The size of the rectangular aperture can be controlled by partial wrapping of the soft moveable flat plats around the substantially vertical cylindrical axis or substantially horizontal cylindrical axis. The shutter assembly in its open position allows air, and light to flow through the rectangular apertures in or out of the enclosure.

The shutter assembly is in its closed position when the moveable soft flat plats are completely unwrapped from the cylindrical axis and overlap the adjacent stationary flat plats. The shutter assembly in its closed position substantially shut flow of air, light, noise and dust from penetrating into the enclosure or flowing out of the enclosure.

These and other objects and advantages of the present invention will no doubt becomes obvious to those of ordinary skill in the art after having read the following detailed description of the preferred embodiments which are illustrated in the various drawing figures.

### BRIEF DESCRIPTION OF THE DRAWINGS

FIG. 1A (Prior Art) illustrates front view of a prior art shutter assembly in a closed position.

FIG. 1B (Prior Art) depicts front view of a prior art shutter assembly in an open position.

FIG. 1C (Prior Art) illustrates front view of a prior art shutter assembly in a closed position.

FIG. 1D (Prior Art) depicts a side view of a prior art shutter assembly in an open position.

FIG. 2A depicts a front view of an embodiment of the present invention with moveable flat plats in an open position.

FIG. 2B illustrates a side view of an embodiment of the present invention with moveable flat plats positioned behind the stationary flat plats.

FIG. 2C illustrates a front view of a rotating knob for lifting the moveable flat plats.

FIG. 3A depicts another embodiment of the present invention where moveable flat plats are partially moved upward adjusting the size of an aperture.

FIG. 3B depicts a side view of the embodiment of the present invention depicted in FIG. 3A where moveable flat plats partially adjust the aperture.

FIG. 4A depicts another embodiment of the present invention with moveable flat plats made out of soft material.

FIG. 4B illustrates an embodiment of the present invention where the plurality of moveable flat plats is wrapped around a plurality of cylindrical rods.

FIG. 4C illustrates the side view of an embodiment of present invention where a lower edge of moveable flat plats made out of soft material overlap the stationary flat plats.

FIG. 5A depicts front view of another embodiment of the present invention with moveable flat plats wrapped around the cylindrical stationary flat plats providing a plurality of rectangular apertures.

FIG. 5B illustrates the side view of an embodiment of present invention where moveable flat plats are wrapped around the cylindrical stationary flat plats.

FIG. 6A illustrates a preferred embodiment of the present invention with two moveable flat plats made out of soft material.

FIG. 6B depicts side view of the preferred embodiment o the present invention when the moveable flat plats are wrapped around a substantially horizontal rod providing two rectangular apertures.

FIG. 6C depicts side view of the preferred embodiment o the present invention when the moveable flat plats are unwrapped and substantially block passage of air and light flow.

### DETAILED DESCRIPTION OF THE DRAWINGS

Reference will now be made in detail to the preferred embodiments of the present invention, an efficient window shutter, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be recognized by one of ordinary skill in the art that the present invention may be practiced without these specific details.

In the following detailed description of the present invention, numerous specific details are set forth in order to provide a thorough understanding of the present invention. However, it will be recognized by one skilled in the art that the present invention may be practiced without these specific details or with equivalents thereof. In other instances, well known methods, procedures, and components have been described in detail as not necessarily obscure aspects of the present invention.

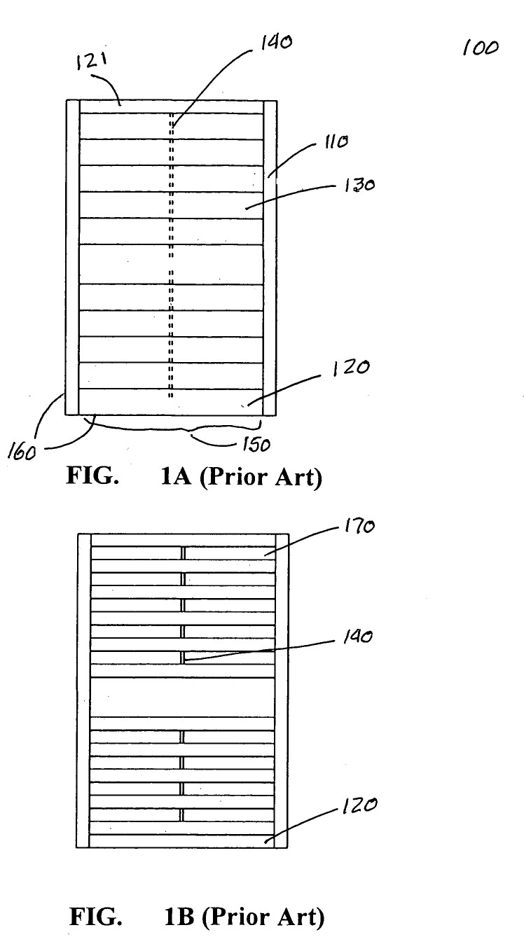

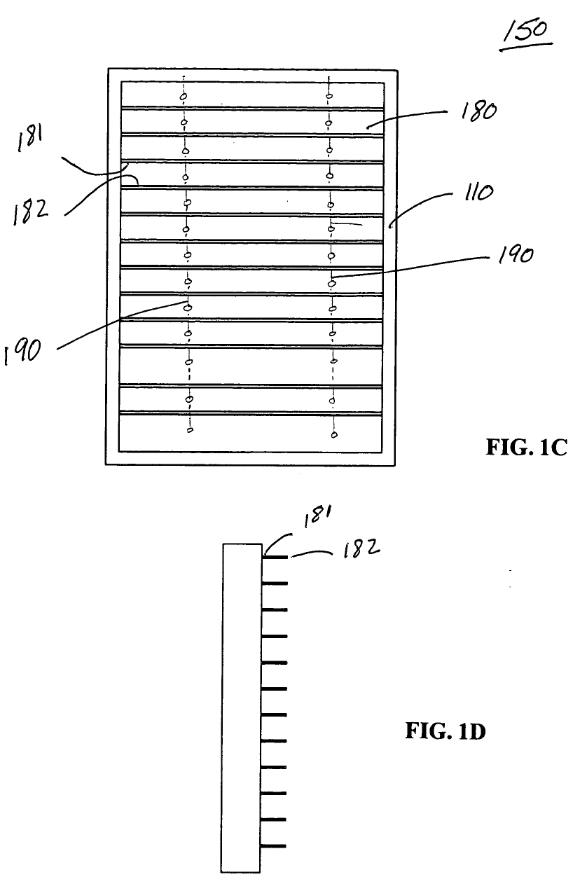

FIG. 1A (Prior Art) depicts shutter assembly 100 that includes a plurality of stiles 110, a plurality of rails 120, a plurality of slats 130 and a plurality of tilt rods 140. The plurality of rail 120 is horizontal members that interlock with the plurality of stile 110 to form perimeter frame 160. Substantially vertical members 110 (also referred to as stiles) and substantially horizontal members 120 (also referred to as rails) are connected together to define an interior area 150. The plurality of slats 130 are pivotally coupled to the substantially vertical members 110. The plurality of tilt rods 140 are moveably coupled to the plurality of slats 130. At least one tilt rod 140 runs from a notch in the top rail 121 to bottom slat 131. A user can close shutter assembly 100 by means of pulling tilt rod 140 upwardly or downwardly.

FIG. 1B (Prior Art) depicts front view of shutter assembly 100 previously illustrated in FIG. 1A (Prior Art) in an open position. Shutter assembly 100, in its open position provides a plurality of apertures 170. The plurality of apertures 170 allow passage of air, light, noise and dust flows into or out of an enclosure where shutter assembly 100 is installed.

FIG. 1C (Prior Art) illustrates shutter assembly 150 that is substantially similar to shutter assembly 100. Shutter assembly 150 includes a plurality of slats 180 and a plurality of cords 190. Each one of the slat of the plurality of slats 180 have an upper edge 181 and a lower edge 182. The upper edge 181 of each of the plurality of slats 180 are hingedly coupled with the plurality of stiles 110. Furthermore, each one of the slat of the plurality of slats 180 can rotate along a substantially horizontal axis. A user can close Shutter assembly 150 by pulling down on at least one cord of the plurality of cords 190 and rotate the plurality of slats 180 to a closed position. In the closed position the lower edge 182 of each one of the slat of the plurality of slats 180 overlaps the upper edge 181 of the adjacent slat of the plurality of slats 180 shutting flow of air or light into or out of an enclosure.

FIG. 1D (Prior Art) illustrates a side view of shutter assembly 150 in its open position. The lower edge of each slat 182 of the plurality of slats 180 protrude into the enclosed area and take some space depending on the width of each one of the slats of the plurality of slats 180.

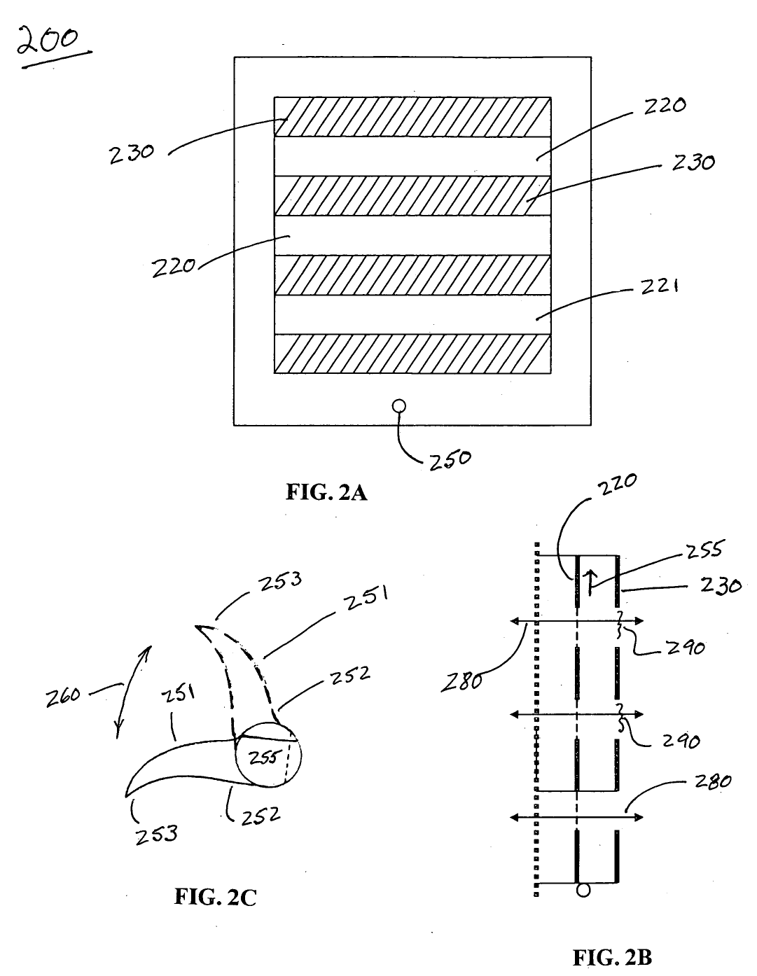

FIG. 2A depicts front view of shutter assembly 200, an embodiment of the present invention, in its open position. Shutter assembly 200 comprises of a plurality of moveable flat plats 220, a plurality of stationary flat plats 230 and at least one knob 250 for lowering down or lifting up the plurality of moveable flat plats 220. The plurality of moveable flat plats 220 has at least one lower flat plat 221 positioned at the lower end of the shutter assembly 200. Knob 250 (described under FIG. 2C) has an extension 251. Extension 251 has a first end 253 and a second end 252. The second end 252 of extension 251 is rotatably coupled to main body 255 of knob 250. Rotatably coupled extension 251 rotates clockwise or counterclockwise in direction 260 of FIG. 2C. According to this embodiment of the present invention, the plurality of moveable flat plats are mechanically coupled such that moving lower flat plat 221 upwardly or downwardly results in moving the plurality of moveable flat plats 220 upwardly or downwardly.

Lower moveable flat plat 221 rests on first end 253 of extension 251. A user can turn knob 250 clockwise or counterclockwise to cause first end 253 of extension 251 to lift up moveable flat plat 221 to a position behind the plurality of stationary flat plats 230. It is appreciated that when moveable flat plats 220 are positioned behind stationary flat plats 230 a plurality of rectangular aperture 290 (FIG. 2B) are provided. Air and light can flow in direction 280 of FIG. 2B in or out of the enclosure through the plurality of rectangular aperture 290 and shutter assembly 200 is in open position.

Similarly, a user can rotate knob 250 clockwise or counterclockwise to cause first end 253 of extension 251 to lower moveable flat plat 220 to a position where moveable flat plats are aligned with the stationary flat plats 230 to its closed position.

FIG. 2B illustrates a side view of an embodiment of the present invention when the plurality of moveable flat plats 220 are positioned behind the plurality of stationary flat plats 230. When the plurality of flat plats 220 are positioned behind the plurality of stationary flat plats 230 the plurality of apertures 290 are provided and flow of air and light can move through the plurality of aperture 290 in direction 280.

FIG. 2C depicts a rotating knob 250. A user can rotate knob 250 in direction 260 causing first end 253 of extension 251 to move the plurality of moveable flat plats 220 upwardly or downwardly. The plurality of moveable flat plats rest on first end 253 of extension 251 under the force of gravity and rotating knob 255 clockwise or counterclockwise neutralizes the force of gravity and pushes the plurality of moveable flat plats 220 upwardly and in a position behind the plurality of stationary flat plats 230.

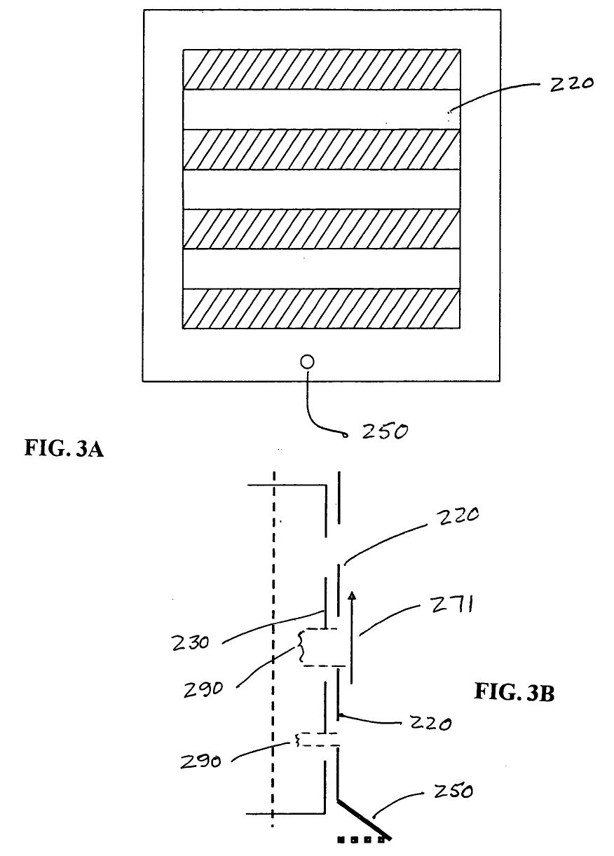

FIG. 3A and FIG. 3B depict another embodiment of the present invention where moveable flat plats 220 are partially lifted upward in direction 271 providing a plurality of rectangular apertures 290. Plurality of rectangular apertures 290 is adjustable, depending on to the amount of air or light flow desired by the user.

FIG. 3B depicts a side view of an embodiment of the present invention where moveable flat plats 220 are positioned partially behind the plurality of stationary flat plats 230 to adjust the plurality of aperture 290 and partially block the air or light flow.

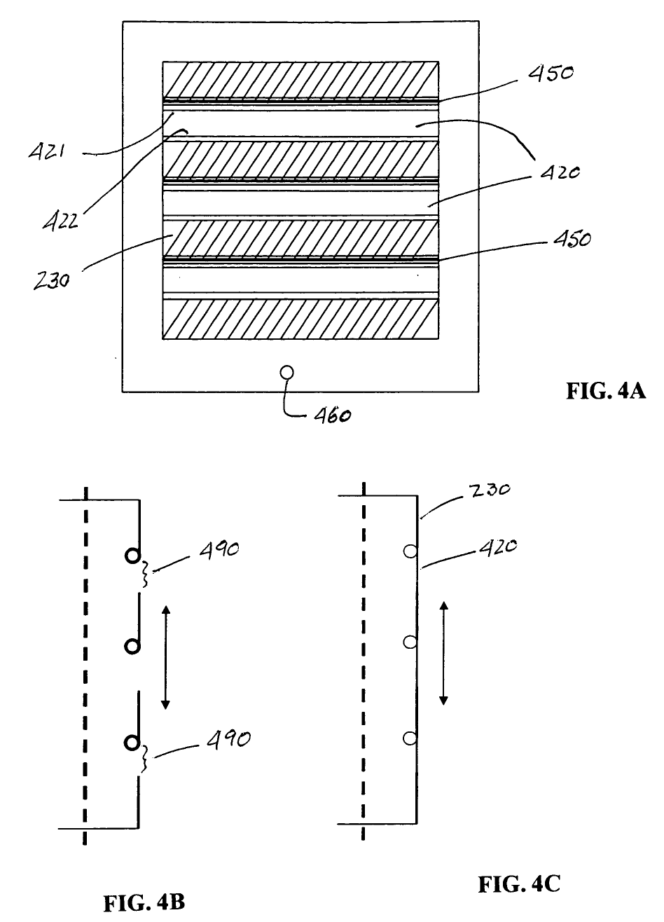

FIG. 4A is a front view of shutter assembly 400, another embodiment of the present invention, in a closed position. Shutter assembly 400 comprises of a plurality of moveable flat plats 420 made out of soft material, a plurality of stationary flat plats 230, a plurality of cylindrical rod 450, and knob 460 adaptable to rotate clockwise or counterclockwise. It is appreciated that knob 460 is mechanically coupled to the plurality of cylindrical rod 450 and rotating knob 460 results in rotation of the plurality of cylindrical rod 450. In this embodiment of the present invention the plurality of moveable flat plats 420 is made of soft material (e.g., cloth, soft plastic, etc. . . . ). Each moveable flat plat of the plurality of moveable flat plats 420 has a first edge 421 and a second edge 422. The first edge 421 of each flat plat of the plurality of flat plats 420 is mechanically coupled to at least one of the plurality of cylindrical rod 450. Knob 460 is rotatably coupled to the plurality of cylindrical rod 450. Rotation of knob 460 causes each one of cylindrical rod 450 of the plurality of cylindrical 450 to rotate. Rotation of the plurality of cylindrical rod 450 causes the plurality of moveable flat plats 420 to wrap around the connecting cylindrical rod of the plurality of cylindrical rod 450.

FIG. 4B illustrates a side view of an embodiment of present invention where the plurality of moveable flat plat 420 is wrapped around the plurality of cylindrical rod 450. Once the plurality of flat plats 420 are wrapped around the plurality of cylindrical rod 450 a plurality of aperture 490 are provided. Provision of the plurality of aperture 490 allows flow of air or light into an enclosure.

FIG. 4C illustrates a side view of an embodiment of present invention where the plurality of moveable flat plat 420 is unwrapped from the plurality of cylindrical rod 450. Once the plurality of flat plats 420 is unwrapped from the plurality of cylindrical rod 450 the plurality of moveable flat plats are place in a position aligned with the plurality of stationary flat plats 230. Second edge 421 of the plurality of moveable flat plat 420 overlaps a top side of adjacent stationary flat plat 230.

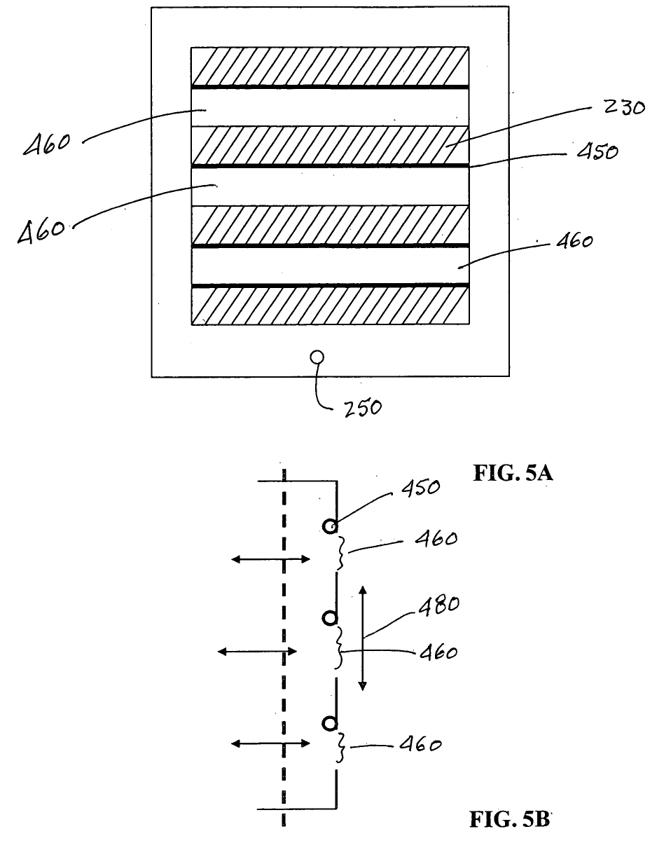

FIG. 5A depicts front view of another embodiment of the present invention with moveable flat plats 420 wrapped around the cylindrical stationary flat plats 450. A plurality of aperture 460 is provided when the plurality of moveable flat plats 420 is wrapped around the plurality of cylindrical rod 450. It is appreciated that the plurality of aperture 460 is adjustable and a user can define the size of the plurality of the aperture 460 by partially wrapping the plurality of the moveable flat plat 420 around the plurality of the cylindrical rod 450.

FIG. 5B illustrates the side view of an embodiment of present invention where the plurality of moveable flat plats 420 is wrapped around the cylindrical rod 450 providing the plurality of aperture 460.

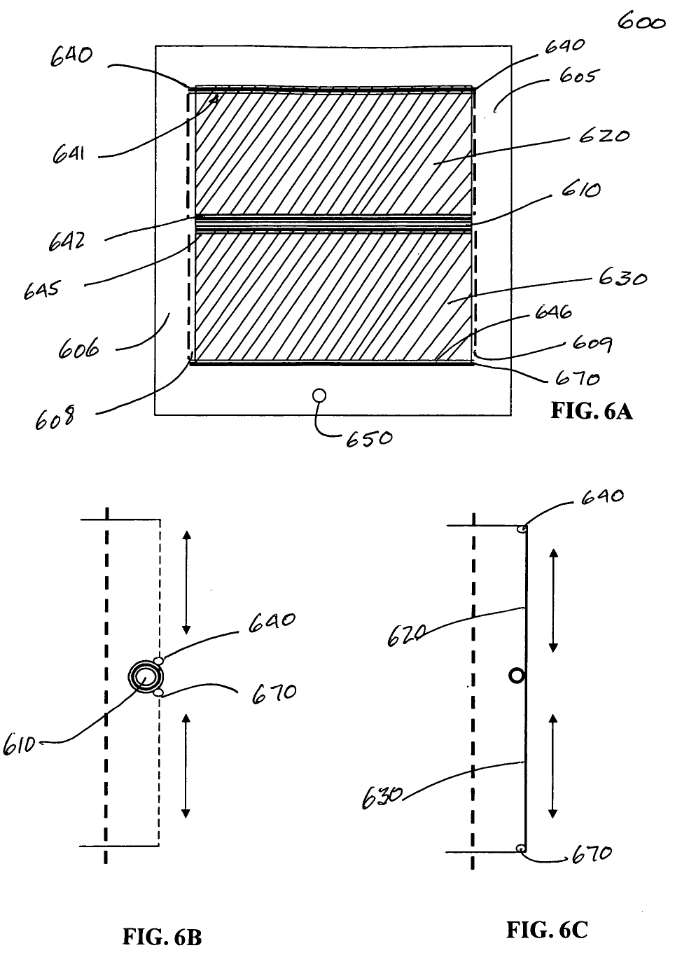

FIG. 6A depicts the preferred embodiment of this invention. Sutter assembly 600 comprises of a cylindrical rod 610, a first moveable flat plats 620 and a second moveable flat plat 630, a first rail 605, a second rail 606 and a knob 650. Flat plat 620 has a top edge 641 and a bottom edge 642. The bottom edge 642 of first moveable flat plat 620 is mechanically coupled to cylindrical rod 610. The top edge 641 of first moveable flat plat 620 is loosely coupled to guide 640. Guide rod 640 is adapted to slide upwardly and downwardly inside guide rail 608 and 609.

The top edge 645 of first moveable flat plat 630 is mechanically coupled to cylindrical rod 610. The bottom edge 646 of moveable flat plat 630 is mechanically coupled to guide rod 670. Guide rod 670 is adapted to slide upwardly and downwardly inside guide rail 608 and 6095.

It is appreciated that FIG. 6A illustrates shutter assembly 600 in its closed position when guide 640 is at the top position and guide 670 is in the bottom position. It is appreciated that cylindrical rod 610 is mechanically coupled to knob 650 and rotation of knob 650 causes guide 640 and guide 670 to move in opposite direction.

FIG. 6B is a side view of shutter assembly 600 in an open position. In an open position, first moveable flat plat 620 and second moveable flat plat 630 are wrapped around cylindrical rod 610, guide rod 640 and guide rod 670 are positioned near cylindrical rod 610.

FIG. 6C is a side view of shutter assembly 600 in a closed position. In a closed position, guide rod 640 is positioned at the extreme top of the shutter assembly 600 and pulls moveable flat plat 620 first moveable flat plat 620 and second moveable flat plat 630 are wrapped around cylindrical rod 610, guide rod 640 and guide rod 670 are positioned near cylindrical rod 610.

While this invention is susceptible of embodiment in many different forms, there is shown in the drawings and will herein be described in detail specific embodiment, with the understanding that the present disclosure is to be considered as an example of the principles of the invention and not intended to limit the invention to the specific embodiment shown and described. In the description below, like reference numerals are used to describe the same, similar or corresponding parts in the several views of the drawings.

In summary, the embodiments of the present invention provide a shutter assembly that provides a shield against unwanted light, air flow or penetration of dust inside an enclosure. Furthermore different embodiment of the present invention provide a user with a shutter assembly which does not protrude inside the enclosure while shield the enclosure against unwanted light, air flow or dust penetration. The present invention further provides a user to use material that can be decorative as well as being protective.

The foregoing description of specific embodiment of the present invention has been presented for purpose of illustration and description. They are not intended to be exhaustive or to limit the invention to the precise form disclosed, and obviously many modifications and variations are possible in light of the above teaching. The embodiments were chosen and described in order to best explain the principles of the invention and its practical application, to thereby enable others skilled in the art to best utilize the invention and various embodiments with various modifications as are suited to the particular use contemplated. It is intended that the scope of the invention be defined by the claims appended hereto and their equivalents.

1. A shutter assembly comprising of:
a plurality of stiles;
a plurality of rails wherein said plurality of rail are coupled with said plurality of stiles to form a substantially rectangular frame;
a plurality of stationary flat plats wherein said plurality of stationary flat plats is coupled to said substantially rectangular frame;
a plurality of moveable flat plats wherein said plurality of moveable flat plats is loosely coupled to said substantially rectangular frame;
means for moving said plurality of moveable flat plats upwardly or downwardly wherein said means for moving the plurality of flat plats is loosely coupled to said plurality of moveable flat plats.

2. A shutter assembly as described in claim 1 wherein said plurality of stationary flat plats are made of wood.

3. A shutter assembly as described in claim 1 wherein said plurality of stationary flat plats are made of metal.

4. A shutter assembly as described in claim 1 wherein said plurality of stationary flat plats are made of cloth.

5. A shutter assembly as described in claim 1 wherein said plurality of stationary flat plats are made of plastic material.

6. A shutter assembly as described in claim 1 wherein said plurality of moveable flat plats are made of wood.

7. A shutter assembly as described in claim 1 wherein said plurality of moveable flat plats are made of cloth.

8. A shutter assembly as described in claim 1 wherein said plurality of moveable flat plats are made of metal.

9. A shutter assembly as described in claim 1 wherein said plurality of moveable flat plats are made of plastic material.

10. A shutter assembly as described in claim 1 wherein said means for moving said plurality of moveable flat plats is a motorized device.

11. A shutter assembly as described in claim 10 wherein said motorized device for moving said plurality of moveable flat plats is remotely controlled.

12. A shutter assembly as described in claim 10 wherein said motorized device for moving said plurality of moveable flat plats is light sensitive

13. A shutter assembly as described in claim 10 wherein said motorized device for moving said plurality of moveable flat plats is temperature sensitive.

14. A shutter assembly as described in claim 10 wherein said motorized device for moving said plurality of moveable flat plats is sound sensitive.

15. A shutter assembly as described in claim 1 wherein said plurality of moveable flat plats are installed horizontally.

16. A shutter assembly as described in claim 1 wherein said plurality of moveable flat plats are installed vertically.

17. A shutter assembly as described in claim 1 wherein said plurality of stationary flat plats are installed horizontally.

18. A shutter assembly as described in claim 1 wherein said plurality of stationary flat plats are installed vertically.

19. A shutter assembly as described in claim 1.
